(19) United States
(12) Patent Application Publication
(10) Pub. No.: US 2012/0234575 A1
(43) Pub. Date: Sep. 20, 2012

(54) CORONA DISCHARGE-RESISTANT INSULATING VARNISH COMPOSITION AND INSULATED WIRE HAVING INSULATED LAYER FORMED THEREFROM

(76) Inventors: Hyung-Sam CHOI, Seoul (KR); Joon-Hee LEE, Gunpo-si (KR); Sun-Joo PARK, Gunpo-si (KR)

(21) Appl. No.: 13/413,695

(22) Filed: Mar. 7, 2012

(30) Foreign Application Priority Data
Mar. 17, 2011 (KR) 10-2011-0023934

(51) Int. Cl. H01B 3/18; C09D 101/08; C09D 179/08

(52) U.S. Cl. 174/110 A; 524/104; 524/45

(57) ABSTRACT

Disclosed is an insulating varnish composition including an organo silica sol containing a silica covered with a dispersant in a solvent containing N-methyl-2-pyrrolidone (NMP) as a main component and a polyamidimide resin dispersed in a solvent containing NMP as a main component. An insulated layer formed from the insulating varnish composition containing inorganic insulating particles of silica uniformly dispersed therein may have excellent corona discharge resistance, thereby preventing the insulation breakdown.

### CROSS-REFERENCE TO RELATED APPLICATION(S)

This application claims priority from Korean Patent Application No. 10-2011-0023934, filed on Mar. 17, 2011, the entire disclosure of which is incorporated herein by reference for all purposes.

### BACKGROUND

1. Field

Exemplary embodiments relate to a corona discharge-resistant insulating varnish composition and an insulated wire having an insulated layer formed from the same.

2. Description of the Related Art

A corona discharge is an electrical discharge brought on by an electric field concentrated at a small crack created in an insulation of an insulated wire or an insulated cable. The corona discharge may deteriorate the insulation properties, which may lead to insulation degradation, and eventually insulation breakdown. In particular, in the case of a coil (or transformer) used in motors and the like, more specifically an enameled wire having a coating formed by coating a conductor with an insulating varnish, followed by curing, a corona discharge may occur between or within the wires (coatings) and heat may be generated due to the decomposition of the coating caused by the collision of charged particles, thereby resulting in insulation breakdown.

Recently, a corona discharge tends to increasingly occur in systems having an inverter motor used for energy saving due to overcharge caused by voltage serge, resulting in insulation breakdown.

To suppress the corona discharge, suggestion has been made to provide an enameled wire having an insulation formed by dispersing inorganic insulating particles such as silica or titania in a solution containing heat-resistant resin dissolved in an organic solvent. The inorganic insulating particles may prevent the occurrence of a corona discharge, and may improve the thermal conductivity, reduce the thermal expansion, and increase the strength of the enameled wire.

In this instance, known methods for dispersing inorganic insulating particles of silica in heat-resistant resin include directly adding silica powder to heat-resistant resin, mixing silica sol with heat-resistant resin, and the like. The silica sol mixes with heat-resistant resin more easily than silica powder, and contributes to an insulating varnish containing highly dispersed silica. For this purpose, silica sol must have high miscibility with heat-resistant resin. When polyamidimide resin dissolved in a solvent is used as a heat-resistant resin solution, the solvent may include N-methyl-2-pyrrolidone (NMP), N,N-dimethylformamide (DMF), N,N-dimethylacetamide (DMAc), and the like. Generally, a mixed solvent of an excessive amount of NMP and a small amount of DMF or alkyl benzene is used.

When silica powder is added to polyamidimide resin dissolved in NMP, silica agglomerates, which results in an insulating varnish having low dispersion of silica. Also, when silica sol is mixed with polyamidimide resin dissolved in NMP, silica agglomerates, which results in an insulating varnish having low dispersion of silica. In this instance, silica sol generally refers to silica dispersed in an alcohol-based organic solvent, and has low miscibility with polyamidimide resin dissolved in NMP.

When an insulating varnish having low dispersion of silica is used in forming an insulated layer, the resulting insulated layer has low corona discharge resistance. The dispersion of silica in the insulating varnish may be temporarily improved under limited conditions, however the insulating varnish may have problems in aspects of long-term storage, stability, reproducibility, and the like.

As a solution, suggestions have been made to mix silica sol produced by dispersing silica powder in gamma-butyrolactone with polyamidimide resin dissolved in gamma-butyrolactone. In this instance, polyamidimide resin dissolved in gamma-butyrolactone may be obtained through a cumbersome operation including extracting polyamidimide resin from polyamidimide resin dissolved in NMP by using ethanol and dissolving the extracted polyamidimide resin in gamma-butyrolactone. Also, gamma-butyrolactone has lower solubility in polyamidimide resin than NMP.

### SUMMARY OF THE INVENTION

The present invention is designed to solve the above problems, and therefore it is an object of the present invention to provide an insulating varnish composition having excellent miscibility between silica and polyamidimide resin, and an insulated wire using the same.

To achieve the object of the present invention, in an aspect of the present invention, there is provided a corona discharge-resistant insulating varnish composition including organo silica sol dispersed in a solvent containing N-methyl-2-pyrrolidone (NMP) as a main component and polyamidimide resin dissolved in a solvent containing NMP as a main component.

In another aspect of the present invention, there is provided an insulated layer formed from an insulating varnish composition including organo silica sol covered with a dispersant dispersed in a solvent containing NMP as a main component and polyamidimide resin dissolved in a solvent containing NMP as a main component.

In this instance, the solvent containing NMP as a main component may include 80 to 100 w % of NMP, and may be mixed with other solvents such as zylene, high-boiling point aromatic solute, and the like.

The organo silica sol may be silica covered with a dispersant, and the dispersant may be at least one selected from the group consisting of polyvinylpyrrolidone, polyethylene imine, polyacrylate, carboxymethyl cellulose, polyacrylamide, polyethylene oxide, and polypropylene oxide, and may have a molecular weight of 5,000 to 1,000,000.

The content of the dispersant may be 10 to 1,000 parts by weight per 100 parts by weight of the silica.

### Advantageous Effects

The insulated layer formed from an insulating varnish composition containing inorganic insulating particles of silica uniformly dispersed therein according to the present invention has excellent corona discharge resistance, thereby preventing the insulation breakdown.

### BRIEF DESCRIPTION OF THE DRAWINGS

FIG. 1 is a transmission electron microscopy (TEM) image of an insulated layer formed from an insulating varnish composition obtained in Example 1.

FIG. 2 is a TEM image of an insulated layer formed from an insulating varnish composition obtained in Comparative Example 1.

### DESCRIPTION OF THE PREFERRED EMBODIMENT

Hereinafter, the present invention will be described in detail.

A corona discharge-resistant insulating varnish composition of the present invention may include organo silica sol dispersed in a solvent containing N-methyl-2-pyrrolidone (NMP) as a main component and polyamidimide resin dissolved in a solvent containing NMP as a main component. Here, the solvent containing NMP as a main component may include NMP alone or in combination with other solvents.

As described above, the present invention is characterized in that the present invention may improve miscibility by dispersing both polyamidimide resin and organo silica sol in the same solvent containing NMP.

When the solvent containing NMP is a mixed solvent, the content of NMP is preferably 80 to 100 w % of the mixed solvent, and the remainder may include xylene, high-boiling point aromatic solute, and the like.

The organo silica sol may refer to colloidal silica covered with a dispersant dispersed in NMP or the mixed solvent. In this instance, the silica may have an average particle diameter of 1 to 100 nm.

The dispersant may include amine-based polymers such as polyvinylpyrrolidone and polyethylene imine; hydrocarbon-based polymers having a carboxylate group such as polyacrylate and carboxymethyl cellulose; polyacrylamide, polyethylene oxide, or polypropylene oxide, singularly or in combination. In this instance, the dispersant may have preferably a molecular weight of 5,000 to 1,000,000. Also, the content of the dispersant may be preferably 10 to 1,000 parts by weight per 100 parts by weight of the silica. When the content is less than 10 parts by weight, it is insufficient to suppress the agglomeration of silica. When the content exceeds 1,000 parts by weight, it is difficult to extract silica covered with a dispersant.

Also, the present invention provides an insulated wire having an insulated layer formed by coating a conductor with the above corona discharge-resistant insulating varnish composition, followed by curing.

### EXAMPLES

Hereinafter, various preferred examples of the present invention will be described in detail for better understanding. However, the examples of the present invention may be modified in various ways, and they should not be interpreted as limiting the scope of the invention. The examples of the present invention are provided so that persons having ordinary skill in the art can better understand the invention.

### Example 1

### Corona Discharge-Resistant Insulating Varnish Composition 1

To prepare the corona discharge-resistant insulating varnish composition of the present invention, organo silica sol was produced; specifically, 100 g of silica and 10 g of a dispersant were reacted in water to treat the surface of the silica with the dispersant, and the silica covered with the dispersant was extracted and dissolved in 200 g of NMP, to obtain organo silica sol.

50 g of the obtained organo silica sol was mixed with 100 g (25% of non-volatile matter) of polyamidimide resin dissolved in NMP, to yield an insulating varnish composition of the present invention.

### Example 2

### Corona Discharge-Resistant Insulating Varnish Composition 2

A corona discharge-resistant insulating varnish composition was prepared in the same way as Example 1, however organo silica sol produced using 100 g of silica and 100 g of a dispersant was used.

### Example 3

### Corona Discharge-Resistant Insulating Varnish Composition 3

A corona discharge-resistant insulating varnish composition was manufactured in the same way as Example 1, however organo silica sol produced using 100 g of silica and 1,000 g of a dispersant was used.

### Comparative Example 1

To produce silica sol, 100 g of silica was dissolved in alcohol. 50 g of the obtained silica sol was mixed with 100 g (25% of non-volatile matter) of polyamidimide resin dissolved in NMP, to prepare an insulating varnish composition of Comparative example 1.

### Experimental Example 1

### Evaluation of Dispersion

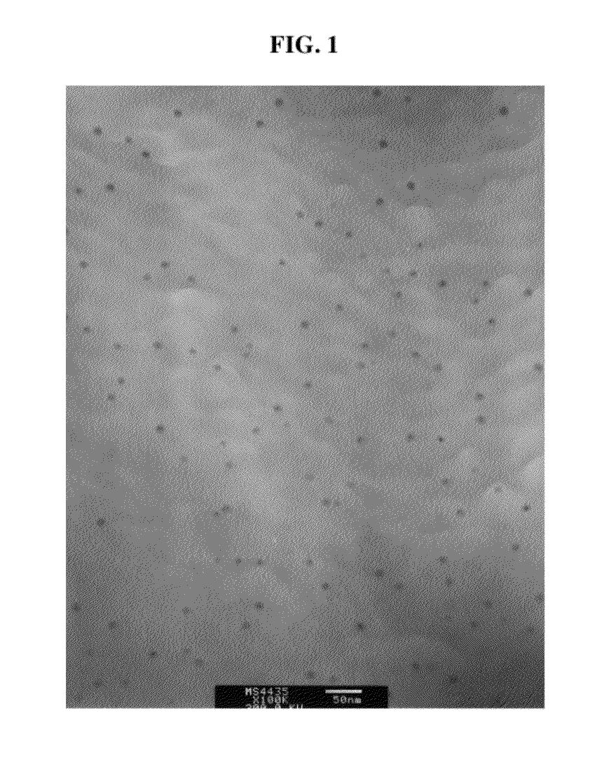

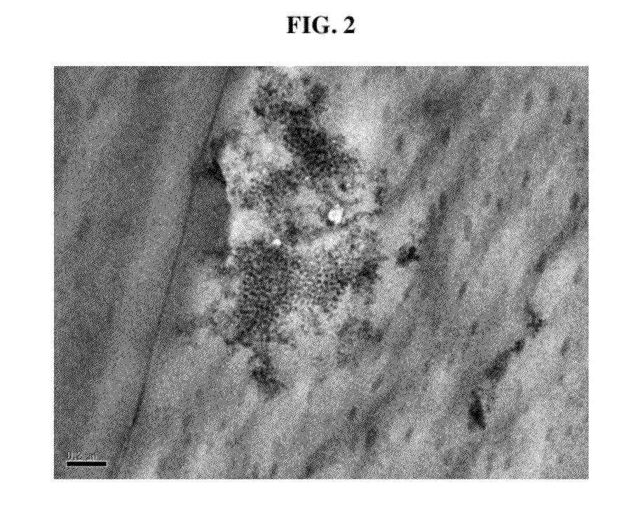

To evaluate the dispersion of silica in the corona discharge-resistant insulating varnish composition of the present invention, a transmission electron microscopy (TEM) image of an insulated layer formed from the insulating varnish composition obtained in Example 1 is shown in FIG. 1. For comparison, a TEM image of an insulated layer formed from the insulating varnish composition obtained in Comparative example 1 is shown in FIG. 2.

From the results of FIGS. 1 and 2, it was found that the insulating varnish composition according to Example 1 of the present invention did not have agglomeration of silica, while the insulating varnish composition according to Comparative example 1 had remarkable agglomeration of silica. That is to say, the present invention may have excellent corona discharge resistance due to excellent dispersion of silica.

Although the present invention has been described hereinabove, it should be understood that the detailed description and specific examples, while indicating preferred embodiments of the invention, are given by way of illustration only, since various changes and modifications within the spirit and scope of the invention will become apparent to those skilled in the art from this detailed description.

What is claimed is:

1. A corona discharge-resistant insulating varnish composition, comprising:
an organo silica sol dispersed in a solvent containing N-methyl-2-pyrrolidone (NMP) as a main component; and
a polyamidimide resin dissolved in a solvent containing NMP as a main component.

2. The corona discharge-resistant insulating varnish composition according to claim 1,
wherein the solvent containing NMP includes 80 to 100 w % of NMP.

3. The corona discharge-resistant insulating varnish composition according to claim 2,
wherein the solvent containing NMP includes xylene or high boiling point aromatic solvent.

4. The corona discharge-resistant insulating varnish composition according to claim 2,
wherein the organo silica sol contains a silica covered with a dispersant.

5. The corona discharge-resistant insulating varnish composition according to claim 4,
wherein the dispersant is at least one selected from the group consisting of polyvinylpyrrolidone, polyethylene imine, polyacrylate, carboxymethyl cellulose, polyacrylamide, polyethylene oxide, and polypropylene oxide.

6. The corona discharge-resistant insulating varnish composition according to claim 5,
wherein the dispersant has a molecular weight of 5,000 to 1,000,000.

7. The corona discharge-resistant insulating varnish composition according to claim 6,
wherein the content of the dispersant is 10 to 1,000 parts by weight per 100 parts by weight of the silica.

8. An insulated wire having an insulated layer formed from an insulating varnish composition including an organo silica sol containing a silica covered with a dispersant in a solvent containing NMP as a main component, and a polyamidimide resin dissolved in a solvent containing NMP as a main component.

9. The insulated wire according to claim 8,
wherein the solvent containing NMP includes 80 to 100 w % of NMP.

10. The insulated wire according to claim 9,
wherein the solvent containing NMP includes xylene or high boiling point aromatic solvent.

11. The insulated wire according to claim 9,
wherein the dispersant is at least one selected from the group consisting of polyvinylpyrrolidone, polyethylene imine, polyacrylate, carboxymethyl cellulose, polyacrylamide, polyethylene oxide, and polypropylene oxide.

12. The insulated wire according to claim 11,
wherein the dispersant has a molecular weight of 5,000 to 1,000,000.

13. The insulated wire according to claim 12,
wherein the content of the dispersant is 10 to 1,000 parts by weight per 100 parts by weight of the silica.
